(19) United States
(12) Patent Application Publication
(10) Pub. No.: US 2024/0332800 A1
(43) Pub. Date: Oct. 3, 2024

(54) DUAL BAND STACKED PATCH ANTENNA WITH SINGLE SIGNAL FEED AND AXIAL RATIO CORRECTING SUPERSTRATE

(71) Applicant: GM Global Technology Operations LLC, Detroit, MI (US)

(72) Inventors: Duane S. Carper, Davison, MI (US); Andrew R. Kahn, Woodland Hills, CA (US); Timothy Brockett, Malibu, CA (US); Hyok Jae Song, Oak Park, CA (US)

(21) Appl. No.: 18/193,176

(22) Filed: Mar. 30, 2023

(51) Int. Cl. H01Q 9/04; H01Q 21/24

(52) U.S. Cl. CPC H01Q 9/0414; H01Q 21/24

(57) ABSTRACT

A dual band stacked patch antenna includes a first patch antenna arrangement coupled to and stacked on a substrate, the first patch antenna arrangement being configured to receive right hand circularly polarized signals in a first frequency band and a second patch antenna arrangement coupled to and stacked on the first patch antenna arrangement, the second patch antenna arrangement being configured to receive right hand circularly polarized signals in a second frequency band. A dielectric superstrate is stacked on the second patch antenna arrangement. Signals in the first and second frequency bands are transmitted to the first and the second patch antenna arrangements through the dielectric superstrate. A single signal feed is shared by both the first patch antenna arrangement and the second patch antenna arrangement and acts to transmit electrical signals representative of the right hand circularly polarized signals in the first and the second frequency bands.

### INTRODUCTION

The present disclosure relates to an antenna for receiving radio signals from a Global Navigation Satellite System (GNSS), which is a general term describing any satellite constellation that provides positioning, navigation, and timing (PNT) services on a global or regional basis. GNSS includes various technologies and satellites such as those comprising the Global Positioning System (GPS) implemented by the United States, and the Global Navigation Satellite System (GLONASS) implemented by Russia, as well as other satellite constellations from other countries and regions. The availability of many satellites over a wide frequency range in GNSS satellite constellations means that antennas for receiving the signals from these satellites often need to be designed to cover two or more different signal bandwidths. Developing an antenna that covers certain required bandwidths while being compliant with desired performance and a desired small antenna size may be a challenge. Additionally, most commercially available antennas do not consider operation under glass due to the frequency detuning and dielectric loading effects that glass presents.

Thus, while current antennas for receiving GNSS radio signals achieve their intended purpose, there is a need for a new and improved antenna for receiving GNSS radio signals, such as for a vehicle.

### SUMMARY

According to several aspects, a dual band stacked patch antenna includes a substrate and a first and a second patch antenna arrangement. The first patch antenna arrangement is coupled to and stacked on the substrate and is configured to receive right hand circularly polarized signals in a first frequency band. The second patch antenna arrangement is coupled to and stacked on the first patch antenna arrangement and is configured to receive right hand circularly polarized signals in a second frequency band. A dielectric superstrate is stacked on the second patch antenna arrangement and the signals in the first and second frequency bands are transmitted to the first and the second patch antenna arrangements through the dielectric superstrate. The antenna includes a single signal feed shared by both the first patch antenna arrangement and the second patch antenna arrangement for transmitting, to a radio unit, electrical signals representative of the right hand circularly polarized signals in the first and the second frequency bands.

In another aspect, the first antenna arrangement includes a ground plane element, a first dielectric substrate layer, and a first metallic patch.

In a further aspect, the second antenna arrangement includes a second dielectric substrate layer and a second metallic patch.

In another aspect, the first metallic patch is square with two corner cuts and the second metallic patch is square with two corner cuts.

In another aspect, the first frequency band includes Global Positioning System (GPS) L5 band frequencies from 1.164 GHz to 1.189 GHz.

In another aspect, the first frequency band includes Global Navigation Satellite System (GLONASS) G3 band frequencies from 1.189 GHz to 1.214 GHz.

In another aspect, the antenna also includes an impedance matching network for the first antenna arrangement.

In another aspect, the superstrate is bonded to a metallic patch of the second antenna arrangement.

In another aspect, the substrate is a printed circuit board.

In another aspect, the antenna arrangements are formed using printed circuit board fabrication techniques.

In another aspect, the single signal feed is directly coupled to a metallic patch of the second antenna arrangement and is capacitively coupled to a metallic patch of first antenna arrangement.

In another aspect, the superstrate comprises a ceramic material and is positioned under glass in a vehicle.

In another aspect, the second frequency band includes Global Positioning System (GPS) L1 band frequencies from 1.563 GHz to 1.587 GHz.

In another aspect, the second frequency band includes Global Navigation Satellite System (GLONASS) G1 band frequencies from 1.593 GHz to 1.610 GHz.

In another aspect, a dual band patch antenna includes a printed circuit board substrate. A first patch antenna arrangement is coupled to and stacked on the substrate. The first patch antenna arrangement is configured to receive right hand circularly polarized signals in a first frequency band, wherein the first frequency band includes Global Positioning System (GPS) L5 band frequencies and Global Navigation Satellite System (GLONASS) G3 band from 1.164 GHz to 1.214 GHz. A second patch antenna arrangement is coupled to and stacked on the first patch antenna arrangement. The second patch antenna arrangement is configured to receive right hand circularly polarized signals in a second frequency band, wherein the second frequency band includes Global Positioning System (GPS) L1 band frequencies and Global Navigation Satellite System (GLONASS) G1 band frequencies from 1.563 GHz to 1.610 GHz. A dielectric superstrate is stacked on the second patch antenna arrangement through which the signals in the first and the second frequency bands are transmitted to the first and the second patch antenna arrangements. The antenna also includes a single signal feed that is shared by both the first patch antenna arrangement and the second patch antenna arrangement for transmitting electrical signals representative of the right hand circularly polarized signals in the first and the second frequency bands.

In another aspect, the antenna further includes an impedance matching network for the first antenna arrangement.

In another aspect, the superstrate is bonded to a metallic patch of the second antenna arrangement.

In another aspect, the substrate is a printed circuit board.

In another aspect, the first and the second antenna arrangements are formed using printed circuit board fabrication techniques.

In another aspect, a dual band patch antenna includes a substrate. A first patch antenna arrangement is coupled to and stacked on the substrate, the first patch antenna arrangement being configured to receive right hand circularly polarized signals in a first frequency band. A second patch antenna arrangement is coupled to and stacked on the first patch antenna arrangement, the second patch antenna arrangement being configured to receive right hand circularly polarized signals in a second frequency band. The antenna further includes a single signal feed shared by both the first patch antenna arrangement and the second patch antenna arrangement for transmitting electrical signals representative of the right hand circularly polarized signals in the first and the second frequency bands, wherein the antenna has an axial ratio of less than 3 dB over the first and the second frequency bands.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system for receiving GNSS signals in a vehicle.

FIG. 2 is a cross-sectional view of an example dual band stacked patch antenna having a superstrate layer.

FIG. 3 is a top view of example antenna of FIG. 2.

FIG. 4 is a simplified cross-sectional view of the example antenna of FIG. 2 illustrating the signal feed pin through the antenna.

FIG. 5 is an example of a bottom side of the printed circuit board substrate of the example antenna of FIG. 2.

FIG. 6 is a perspective view of the example antenna of FIG. 2.

FIG. 7 is a cross-sectional view of another example dual band patch antenna without a superstrate layer.

FIG. 8 illustrates measured performance of the example antenna of FIG. 2.

### DETAILED DESCRIPTION

The following description is merely exemplary in nature and is not intended to limit the present disclosure, application, or uses. For the sake of brevity, conventional techniques and aspects related to a dual band stacked patch GNSS receiver antenna may not be described in detail herein. In addition, those skilled in the art will realize that embodiments of the dual band stacked patch antenna described herein may be practiced in conjunction with any number of applications and deployment in a vehicle as described herein is merely one suitable example.

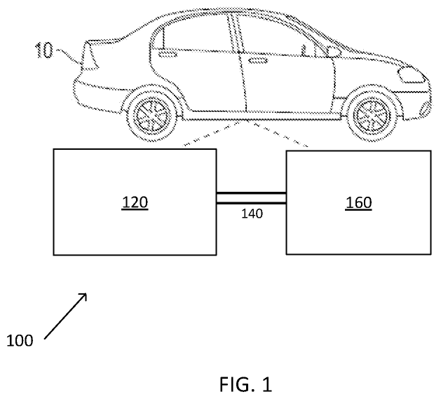

Referring to FIG. 1, a block diagram of a system 100 for receiving GNSS signals for a vehicle 10 is illustrated which generally includes an antenna 120, a transmission line 140, and a radio unit 160. The antenna 120 acts as an interface between GNSS radio signals propagating through the environment from satellites and the system 100 by transforming received radio signals to electrical signals. The electrical signals are communicated to radio unit 160 via the transmission line 140. The radio unit 160 includes known components, such as one or more filters, a low noise amplifier (LNA), and the like, to receive and process the electrical signals in relevant GNSS bandwidths for specific applications.

The transmission line 140 may be a specialized cable designed to conduct electromagnetic waves in a contained manner. The transmission line 140 is designed to minimize power losses between the antenna 120 and the radio unit 160. For example, the transmission line 140 may be impedance matched to the antenna 120 and the radio unit 140 to minimize reflections and thus power losses.

More specifically, the antenna 120 is a dual band stacked patch antenna that receives GNSS radio signals from the environment and transmits electrical currents representative of the received radio signals to the transmission line 140 and then radio unit 160 via a signal feed. The dual band stacked patch antenna 120 described herein includes two patch antenna arrangements and achieves a wide bandwidth, high gain, small size, and good coverage. The antenna 120 can be produced using simple printed circuit board (PCB) fabrication techniques. The antenna 120 with a superstrate may be used under glass, such as in vehicle 10, and provides wide coverage for GNSS frequency bands to simultaneously cover, for example, GPS L1 and GLONASS G1 bands with one antenna arrangement and GPS L5 and GLONASS G3 bands with another antenna arrangement.

TABLE 1 below illustrates the different frequencies used by the GPS and GLONASS constellations (though slightly different numbers may be published elsewhere depending on how the signal bandwidths are defined.)

TABLE 1
Frequencies (MHz)

| System | L1 Band | L5 Band | G1 Band | G3 Band |
|---|---|---|---|---|
| GPS | 1563-1587 | 1164-1189 | N/A | N/A |
| GLONASS | N/A | N/A | 1593-1610 | 1189-1214 |

GNSS satellites use signals with right hand circular polarization (RHCP) and therefore the antenna 120 is designed to receive RHCP signals and capture the maximum available power. To create circular polarization, the antenna 120 must accept or transmit two orthogonal electric field components that have equal magnitude and have a 90-degree phase delay between them. The quality of the circular polarization can be specified by the ratio of a cross polar component with respect to a co-polar component (RHCP to LHCP components) or by specifying the axial ratio (AR). The AR is the measure of the polarization ellipticity of an antenna designed to receive circularly polarized signals. An AR close to 1 (or 0 dB) is best and indicates a good circular polarization. An axial ratio from less than 3 dB may be achieved with the antenna 120 over the frequency bands of interest as further described herein.

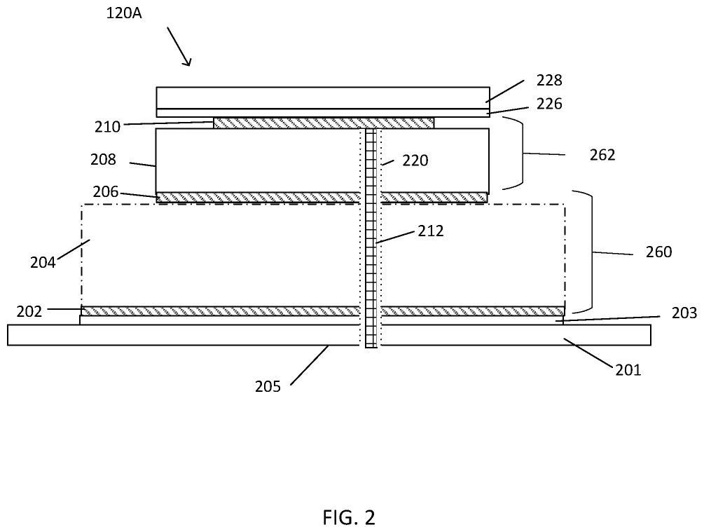

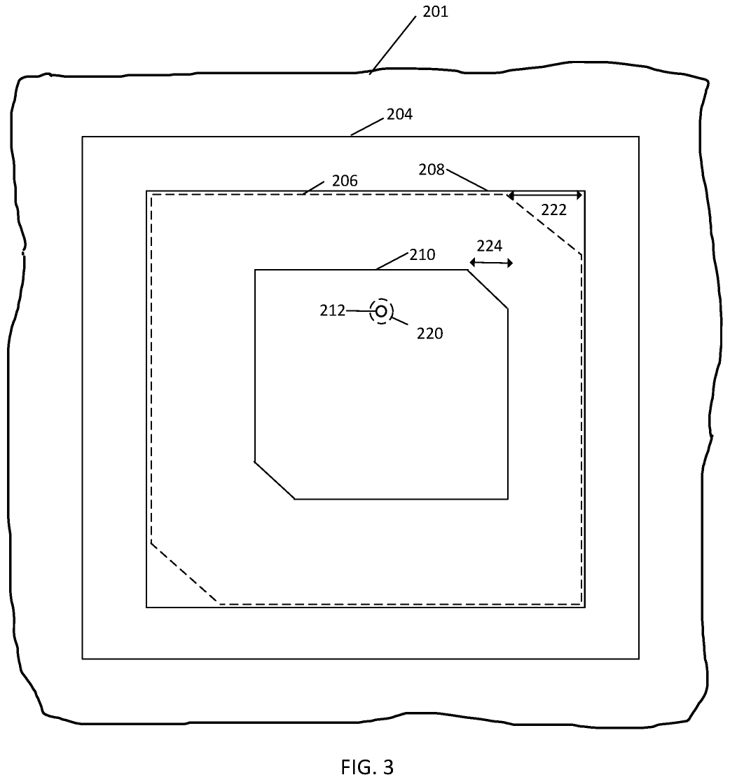

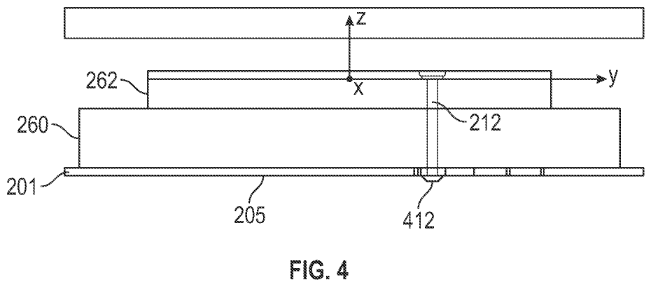

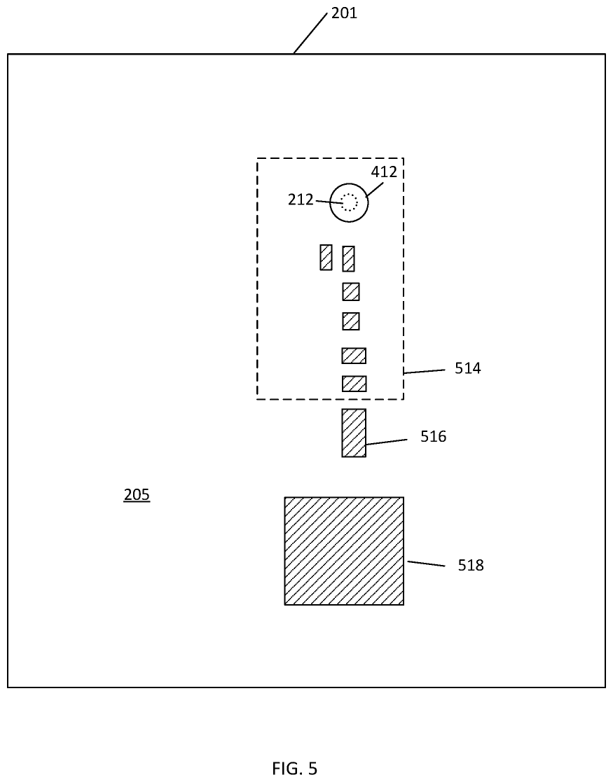

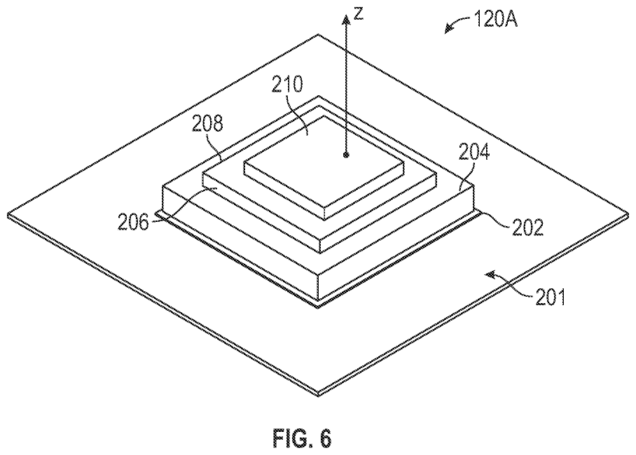

FIG. 2 is a cross-sectional view illustrating the layers that make up an example dual band stacked patch antenna 120A for receiving GNSS signals, with the antenna 120A including a superstrate 228. FIG. 3 is a top view of antenna 120A showing various layers of example antenna 120A (but not showing the superstrate layer). FIG. 4 is a simplified cross-sectional view of example antenna 120A showing details of the single signal feed pin 212 through the two antenna arrangements and printed circuit board (PCB) substrate 201 to output signal port 412. FIG. 5 is a view of the underside of the PCB substrate 201 of example antenna 120A. FIG. 6 is a perspective view of example antenna 120A.

Referring to FIGS. 2-6, example antenna 120A is a microstrip dual band stacked patch antenna with multiple layers. By stacking multiple layers of dielectric material and various sized conductors, which are associated with different resonant frequencies, multiple antenna arrangements can be integrated into the same structure. Each antenna arrangement operates by excitation of a resonant mode in a dielectric material with conductors on either side. The fringing electric and magnetic fields at the edges of the conductors radiate into free space. In this case, antenna 120A includes a first (lower) patch antenna arrangement 260 configured to receive signals in a first frequency band (e.g., GPS signals in the L5 band and/or GLONASS signals in the G3 band) and a second (upper) patch antenna arrangement 262 configured to receive signals in a second frequency band (e.g., GPS signals in the L1 band and/or GLONASS signals in the G1 band). The second patch antenna arrangement 262 is coupled to and stacked on the first patch antenna arrangement 260, which is supported by printed circuit board substrate 201. The lower antenna arrangement 260 acts as the ground plane for the upper antenna arrangement and a single signal feed pin 212 provides electric signals to the underside of the PCB substrate 201 of antenna 120A and ultimately to radio unit 160.

The illustrated example antenna 120A of FIGS. 2-6 includes, as best seen in FIG. 2, PCB substrate 201 that supports the first and the second antenna arrangements 260, 262, which may be secured to the substrate 201 via adhesive tape 203. First antenna arrangement 260 includes a ground plane element 202, a first dielectric layer 204, and a first radiating element or patch 206. Second antenna arrangement 262 includes a second dielectric layer 208 and a second radiating element or patch 210. Superstrate 228 and bonding layer 226 form the top of the structure. Essentially, the superstrate 228 layer acts to pre-distort the radiated signals from the satellites that are transmitted through glass and then through the superstrate to the antenna arrangements 260, 262. A signal feed in the form of signal feed pin 212 is connected to the second radiating element 210 and signal port 412 (see FIG. 4) of PCB substrate 201.

As shown in FIG. 2, first dielectric layer 204 is located between, and physically separates, ground plane element 202 and first radiating element 206. Similarly, second dielectric layer 208 is located between, and physically separates, first radiating element 206 and second radiating element 210. When deployed, second radiating element 210 will be the upper radiating element of antenna 120A, the first radiating element 206 will be the lower radiating element of antenna 120A. In some cases, first radiating element 206 is sandwiched within the dielectric material and no portion of first radiating element 206 is exposed.

As mentioned, the ground plane element 202, first dielectric layer 204, and first radiating element 206 form part of the first antenna arrangement 260, while second dielectric layer 208 and second radiating element 210 form part of the second antenna arrangement 262. In this regard, first dielectric layer 204 can be one substrate that includes ground plane element 202 and first radiating element 206, and a second dielectric layer 208 can be another substrate coupled to second radiating element 210. The first patch antenna arrangement 260 can be formed as one separate component (for example a first ceramic layer of a first thickness with metallization areas) and the second patch antenna arrangement can be fabricated independently as another separate component (for example, a second ceramic layer of a second thickness with metallization areas), with the two substrates being coupled together during a subsequent processing step, using lamination, bonding, or any suitable technique, such that first radiating element 206 is located between first dielectric layer 204 and second dielectric layer 208 as shown.

First dielectric layer 204 and second dielectric layer 208 may be formed from a common dielectric material. The dielectric material used to form dielectric layers 204 and 208 may be, for example, a microwave material with an isotropic dielectric constant (Dk) of 9.8, such as Rogers TMM 10i, which is a ceramic thermoset polymer composite designed for strip-line and microstrip applications and which is compatible with known printed circuit board processing techniques. The metallization on dielectric layers 204 and 208 may be formed from copper cladding, gold coated copper cladding, or the like using commercial thin film processes.

In particular, the first antenna arrangement may be fabricated by forming thin metal layers on the top and bottom exposed surfaces of dielectric layer 204. Thereafter, the metal layers can be selectively removed or patterned using well known techniques, such as by masking, photolithography, and etching, to create the desired size, shape, and features of ground plane element 202, first radiating element 206, and apertures, such as hole 220 described below. Likewise, the second antenna arrangement may be fabricated by forming a thin metal layer on the top exposed surface of dielectric layer 208, followed by selective removal of the metal to create the desired size, shape, and features of second radiating element 210. The thickness of the metal layers for the first and the second antenna arrangements will depend upon the particular dielectric material, the type of metal used, the substrate fabrication technique, and desired performance characteristics. For example, the thickness of the metal layers in practical embodiments may be within the range of about 8 to 35 micrometers.

Ground plane element 202 functions as a ground plane for both first radiating element 206 and second radiating element 210.

The antenna 120A utilizes only one signal feed, which is shared by both patch antenna arrangements 260, 262. The signal feed may be realized as a solid conductor, a conductive wire, a standard sized RF connector pin, or a conductive tube. Here single signal feed pin 212 is used to couple signals from first radiating element 206 and second radiating element 210. Notably, signal feed pin 212 physically contacts only one of the two radiating elements, and in the example antenna 120A, signal feed pin 212 is in direct electrical contact with second radiating element 210 and has no direct physical contact with first radiating element 206 but is capacitively coupled thereto. Signal feed pin 212 may be connected to the upper or lower surface of second radiating element 210 and the antenna includes a hole 220 (which may have varying diameters though different layers) to accommodate signal feed pin 212 through several other layers, such that signal feed pin 212 extends through dielectric layer 208, first radiating element 206, dielectric layer 204, ground plane element 202, and PCB substrate 201. Importantly, signal feed pin 212 does not contact the first radiating element, the ground plane element 202, or other ground metal components of the substrate 201.

During fabrication, a properly sized hole 220 can be drilled through the dielectric materials 208, 204, either stopping at second radiating element 210 or through second radiating element 210. Then signal feed pin 212, which may be realized as a standard SMA pin, can be inserted into the hole and into contact with second radiating element 210. After installation, signal feed pin 212 may be flush against the dielectric material although a slight gap may exist between the dielectric material and the outer surface of signal feed pin 212. Signal feed pin 212 may be soldered or otherwise affixed to second radiating element 210. Signal feed pin 212 extends through the hole 220 in the various layers to the bottom side 205 of PCB substrate 201.

Signal feed pin 212, the dielectric material, and hole 220 cooperate to function as an aperture coupler for first radiating element 206. In other words, signal feed pin 212 is capacitively coupled (aperture coupled) to first radiating element 206, and without any physical contact with first radiating element 206 itself. For the illustrated embodiment, the diameter of the aperture 220 is influenced by the diameter of signal feed pin 212, the type of dielectric material, the output impedance of antenna 120A, the desired amount of coupling, and the frequency of the signals to be coupled. Thus, signals received by first radiating element 206 are capacitively coupled to signal feed pin 212, while signals received by second radiating element are directly coupled to signal feed pin 212. Accordingly, first radiating element 206, dielectric material 204, signal feed pin 212 and ground plane element 202 cooperate to receive signals in a first frequency band, while second radiating element 210, the dielectric material 208, signal feed pin 212, and ground plane element 202 cooperate to receive signals in a second frequency band.

In practice, the aperture coupling mechanism is arranged to minimize sensitivity to manufacturing and assembly inconsistencies. Large aperture diameters tend to be less sensitive to both the exact feed placement within the aperture and to variations in the dimensions of the aperture. In example antenna 120A, the diameter of the aperture 220 at the first radiating element 206 may be 2.5 millimeters and the diameter of the signal feed pin 212 may be about 1.0 millimeter. Moreover, as mentioned, antenna 120A lacks any intervening interconnects or shorting pins between ground plane element 202, first radiating element 206, and second radiating element 210.

The position of signal feed pin with respect to the radiating elements is chosen such that the input impedance at that point with respect to an antenna edge is equal to 50 ohms, for both of the antenna arrangements. As illustrated in FIG. 3, in this embodiment, first radiating element 206 is generally centered relative to dielectric layers 204 and 208, while second radiating element 210 is offset with respect to first radiating element 206 in order to obtain the appropriate input impedances for both antenna arrangements.

Ground plane element 202 is physically isolated from first radiating element 206 and from second radiating element 210, and first radiating element 206 is physically isolated from second radiating element 210. This relatively simple structure is therefore easy to manufacture and assemble. The actual size, shape, and arrangement of elements in dual band patch antenna 120A may vary depending upon the particular application, packaging constraints, desired materials, manufacturing considerations, and other practical influences. The embodiment described with reference to FIGS. 2-6 is merely one suitable implementation, wherein both dielectric layers are formed from the same material.

The signal feed pin 212 is connected to output signal port 412 on the bottom side 205 of the PCB substrate 201 as shown in FIG. 4. As shown in FIG. 5, ground 518, formed as a pigtail connector pad, on the bottom side 205 of PCB substrate 201 connects to ground plane element 202 in a known manner, such as through vias and conductive traces (e.g., copper) of the PCB substrate 201. In typical vehicle installations, ground plane element 202/ground 518 can be electrically coupled to a conductive sheet or a component of the vehicle, such as the roof, a fender, trunk lid, or the like.

The PCB substrate 201 may be double sided with solder mask covering top and bottom surfaces except in desired areas. The PCB substrate 201 may have dimensions of 100 millimeters by 100 millimeters, with a thickness of 0.8715 millimeters.

The first dielectric layer 204 may have dimensions of approximately 50 millimeters by 50 millimeters, with a thickness of about 7.62 millimeters, while the second dielectric layer 208 may have dimensions of 37.44 millimeters by 37.44 millimeters, with a thickness of about 3.81 millimeters. First radiating element/patch 206 (shown in dashed lines in FIG. 3 because it is actually hidden from view and sandwiched between the dielectric layers 204 and 208) may be formed with dimensions of 36.5 millimeters by 36.5 millimeters with truncated opposing corners as depicted in FIGS. 3 and 6. Second radiating element 210 may be formed with dimensions of 27.5 millimeters by 27.5 millimeters with truncated opposing corners corresponding to the truncated corners of first radiating element 206.

These 45 degree mitered cuts in opposing corners are designed to excite two counter-propagating orthogonal modes that are close enough in frequency to provide a 90 degree phase shift in the desired band to achieve RHCP operation for the desired GNSS frequencies. The dimension 222 for the cut corners of the first radiating element 206 is 5.45 millimeters for antenna 120A, utilized to achieve RHCP operation for GPS L5 band and GLONASS G3 band. The dimension 224 for the cut corners of the second radiating element 210, utilized to achieve RHCP operation for GPS L1 band and GLONASS G1 band, is 3.1 millimeters in this example.

The prepreg layer 226 is a bonding/insulating material between the superstrate layer 228 and the second radiating patch and may have dimensions of 37.44 millimeters by 37.44 millimeters with a thickness of 25.4 microns (1 mil) and may be Rogers R2929 material with a Dk of 2.9. Superstrate 228 may also have dimensions of 37.44 by 37.44 millimeters with a height of 1.27 millimeters and may be a ceramic material such as Rogers TMM6 having a Dk of 6. The adhesive layer 203 may be a 0.16 millimeter thick Nitto 5000 NS tape.

Given the physical dimensions of first radiating element 206 and second radiating element 210, the dielectric material for the dielectric layers 204/208 and superstrate 228 may be selected to obtain the appropriate center frequencies of operation. Conversely, given the dielectric constants of the materials chosen for dielectric layers 204/208 and superstrate 228, the physical dimensions could then be selected to obtain the appropriate center frequencies of operation.

The same dielectric material may, but need not, be chosen for both dielectric layers 204, 208. The selection of the same dielectric material is desirable to minimize material costs and to simplify the manufacturing process. Fine tuning of the various physical parameters, such as the corner truncation dimensions, overall size of the metallization areas, overall size of dielectric layers, the offset of the radiation elements 206/210 relative to signal feed pin 212, and the dimensions of aperture 220 may be employed to achieve the desired performance for the designated frequency bands.

Signal port 412 includes a connector such that the received GNSS signals can be propagated from signal feed pin 212 of dual band stacked patch antenna 120A to integrated matching network 514. Matching network 514 operates to widen the bandwidth of the first frequency band of interest, here the GPS L5 and GLONASS L3 band, and may take the form of surface mount components that can be mounted to the bottom side 205 of substrate 201. Matching network 514 is connected to connector pad 516.

Signal port 412 isolates signal feed pin 212 from contact with portions of PCB substrate 201 using well known principles. Connector pad 518 is a ground and is connected to ground element 202. Connector pads 516 and 518 couple the electrical signals representative of GNSS radio signals to the transmission line 140 and then to radio unit 160.

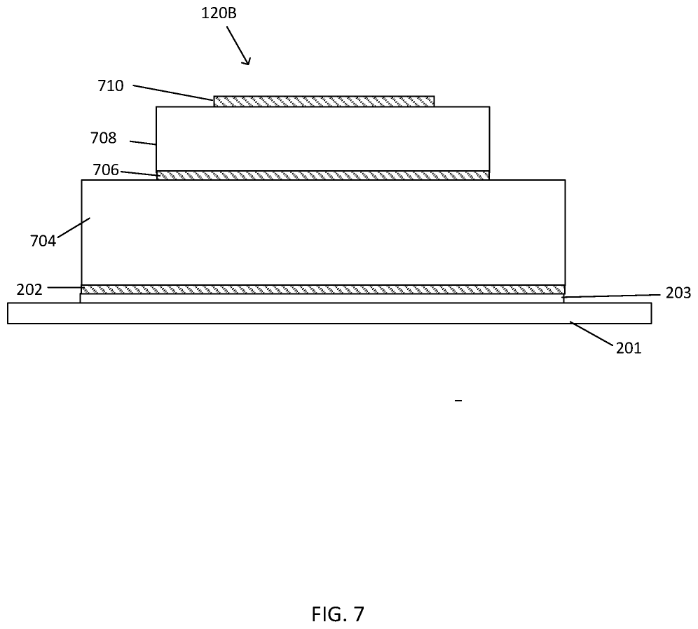

FIG. 7 illustrates an example antenna 120B without a superstrate, which is like example antenna 120A, though with slightly different dimensions for certain components. Note also that antenna 120B includes a single signal feed, though it is not shown in FIG. 7. Antenna 102B includes a first dielectric layer 704, which may have dimensions of approximately 50 millimeters by 50 millimeters, with a thickness of about 7.62 millimeters, while the second dielectric layer 708 may have dimensions of 37.44 millimeters by 37.44 millimeters, with a thickness of about 3.81 millimeters. First radiating element/patch 706, sandwiched between the dielectric layers 704 and 708 may be formed with dimensions of 37.5 millimeters by 37.5 millimeters with truncated opposing corners. Second radiating element 710 may be formed with dimensions of 29 millimeters by 29 millimeters with truncated opposing corners corresponding to the truncated corners of first radiating element 706. Antenna 120B is not meant to be placed under glass, but this example antenna also provides for a less complex radio unit with the same AR of less than 3 dB and may be used in applications where positional accuracy is important.

The dimension for the cut corners of the first radiating element 706 is 5.45 millimeters for antenna 120B, utilized to achieve RHCP operation for GPS L5 band and GLONASS G3 band. The dimension for the cut corners of the second radiating element 710, utilized to achieve RHCP operation for GPS L1 band and GLONASS G1 band, is 3.3 millimeters in this example.

Dimensions of components 201, 202, 203 remain the same for both antennas 120A, 120B. Materials used for both antennas are also the same.

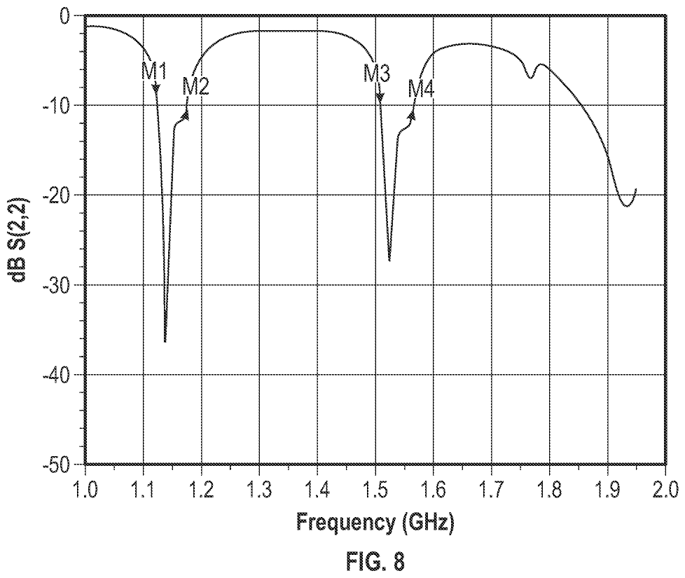

A dual band stacked patch antenna 120A having the characteristics described above was tested. FIG. 8 is a plot of the measured return loss of the antenna under glass. Although the frequency is shifted (this can be fixed), what is important is that the bandwidth of the L5 band is 52.1 MHz and the bandwidth of the L1 band is 57.3 MHz. This is more than any commercially available dual band stacked patch antenna. Specifically, in this case, M1 is 1.122 GHz, M2 is 1.174 GHz, with a center frequency of 1.148 (which is shifted from L5 center frequency). M3 is 1.507 GHz and M4 is 1.564, with a center frequency of 1.535 (which is shifted 40 MHz from L1 center frequency).

The antennas of the present disclosure offer several advantages. For example, the present disclosure provides an antenna to transmit signals from different bandwidths with a desirable AR, such as less than 3 dB. Notably, antenna 120 utilizes only one signal feed 212 to propagate the dual band signals; this simplifies fabrication and installation of antenna 120A and reduces cost, especially compared to standard dual band stacked patch antenna designs which use two pins to feed each patch independently. Because the antenna 120 as described herein uses a single signal feed pin 212 to feed both radiating elements 206, 210, this eliminates the need for separate low noise amplifiers for each feed pin, 90 degree hybrid couplers to split the signal and provide a phase shift, and 50 ohm surface mount termination resistors for such hybrid couplers. This reduces the complexity of the radio unit.

Further, the antenna 120A with a superstrate may be placed under glass (having a dielectric constant between 4 and 15), without perturbation of the axial ratio. Glass inherently detunes the operating frequency of the antenna and distorts its axial ratio, caused by the dielectric loading effects of the glass. This is overcome by the thin dielectric superstrate having a refractive index greater than one between the antenna and the glass. The subsequent dielectric refraction that the radiated field undergoes through the superstrate layer essentially pre-distorts the electromagnetic field vectors of the GNSS radio signals, compensating for the distortion that the glass introduces. Placement of the antenna under glass eliminates the need for external “shark fin” type antennas on vehicles.

The use of a single transmission line provides a lower cost system having fewer components, a lower mass, higher reliability, and a more compact design as compared to other antennas having multiple patch antenna arrangements each having a separate signal feed to signal processing components.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A dual band stacked patch antenna comprising:
a substrate;
a first patch antenna arrangement coupled to and stacked on the substrate, the first patch antenna arrangement being configured to receive right hand circularly polarized signals in a first frequency band;
a second patch antenna arrangement coupled to and stacked on the first patch antenna arrangement, the second patch antenna arrangement being configured to receive right hand circularly polarized signals in a second frequency band;
a dielectric superstrate stacked on the second patch antenna arrangement, wherein the signals in the first and second frequency bands are transmitted to the first and the second patch antenna arrangements through the dielectric superstrate; and
a single signal feed shared by both the first patch antenna arrangement and the second patch antenna arrangement for transmitting, to a radio unit, electrical signals representative of the right hand circularly polarized signals in the first and the second frequency bands.

2. The antenna of claim 1, wherein the first antenna arrangement includes a ground plane element, a first dielectric substrate layer, and a first metallic patch.

3. The antenna of claim 2, wherein the second antenna arrangement includes a second dielectric substrate layer and a second metallic patch.

4. The antenna of claim 3, wherein the first metallic patch is square with two corner cuts and the second metallic patch is square with two corner cuts.

5. The antenna of claim 1, wherein the first frequency band includes Global Positioning System (GPS) L5 band frequencies from 1.164 GHz to 1.189 GHz.

6. The antenna of claim 5, wherein the first frequency band includes Global Navigation Satellite System (GLONASS) G3 band frequencies from 1.189 GHz to 1.214 GHz.

7. The antenna of claim 6, further comprising an impedance matching network for the first antenna arrangement.

8. The antenna of claim 1, wherein the superstrate is bonded to a metallic patch of the second antenna arrangement.

9. The antenna of claim 1, wherein the substrate is a printed circuit board.

10. The antenna of claim 1, wherein the antenna arrangements are formed using printed circuit board fabrication techniques.

11. The antenna of claim 1, wherein the single signal feed is directly coupled to a metallic patch of the second antenna arrangement and is capacitively coupled to a metallic patch of first antenna arrangement.

12. The antenna of claim 1, wherein the superstrate comprises a ceramic material and is positioned under glass in a vehicle.

13. The antenna of claim 1, wherein the second frequency band includes Global Positioning System (GPS) L1 band frequencies from 1.563 GHz to 1.587 GHz.

14. The antenna of claim 13, wherein the second frequency band includes Global Navigation Satellite System (GLONASS) G1 band frequencies from 1.593 GHz to 1.610 GHz.

15. A dual band patch antenna comprising:
a printed circuit board substrate;
a first patch antenna arrangement coupled to and stacked on the substrate, the first patch antenna arrangement being configured to receive right hand circularly polarized signals in a first frequency band, wherein the first frequency band includes Global Positioning System (GPS) L5 band frequencies and Global Navigation Satellite System (GLONASS) G3 band from 1.164 GHz to 1.214 GHz;
a second patch antenna arrangement coupled to and stacked on the first patch antenna arrangement, the second patch antenna arrangement being configured to receive right hand circularly polarized signals in a second frequency band, wherein the second frequency band includes Global Positioning System (GPS) L1 band frequencies and Global Navigation Satellite System (GLONASS) G1 band frequencies from 1.563 GHz to 1.610 GHz;
a dielectric superstrate stacked on the second patch antenna arrangement, wherein the signals in the first and the second frequency bands are transmitted to the first and the second patch antenna arrangements through the dielectric superstrate; and
a single signal feed shared by both the first patch antenna arrangement and the second patch antenna arrangement for transmitting electrical signals representative of the right hand circularly polarized signals in the first and the second frequency bands.

16. The antenna of claim 15, further comprising an impedance matching network for the first antenna arrangement.

17. The antenna of claim 15, wherein the superstrate is bonded to a metallic patch of the second antenna arrangement.

18. The antenna of claim 15, wherein the substrate is a printed circuit board.

19. The antenna of claim 15, wherein the first and the second antenna arrangements are formed using printed circuit board fabrication techniques.

20. A dual band patch antenna comprising:
a substrate;
a first patch antenna arrangement coupled to and stacked on the substrate, the first patch antenna arrangement being configured to receive right hand circularly polarized signals in a first frequency band;
a second patch antenna arrangement coupled to and stacked on the first patch antenna arrangement, the second patch antenna arrangement being configured to receive right hand circularly polarized signals in a second frequency band; and
a single signal feed shared by both the first patch antenna arrangement and the second patch antenna arrangement for transmitting electrical signals representative of the right hand circularly polarized signals in the first and the second frequency bands, wherein the antenna has an axial ratio of less than 3 dB over the first and the second frequency bands.
